(19) United States
(12) Patent Application Publication
(10) Pub. No.: US 2009/0192881 A1
(43) Pub. Date: Jul. 30, 2009

(54) METHODS OF ADVERTISING USING DIGITAL STAMPS

(76) Inventor: Joseph R. PIERRE, Washington, DC (US)

Correspondence Address: CASTELLANO PLLC, P.O. Box 1555, Great Falls, VA, 22066, US

(21) Appl. No.: 12/360,451

(22) Filed: Jan. 27, 2009

Related U.S. Application Data
(60) Provisional application No. 61/023,897, filed on Jan. 28, 2008.

(51) Int. Cl. G06Q 30/00; G06F 17/00; G06Q 10/00

(52) U.S. Cl. 705/10; 707/104.1; 705/14

(57) ABSTRACT

Provided are methods that include using a computer to insert digital stamp advertisements from corporations, small businesses, non-profit organizations and the like, into a user's email, social networking website or web communication. The digital stamp may be an intelligent file having computer code embedded thereon, such that the digital stamp is capable of gathering and/or reporting data regarding use of the digital stamp. Example methods include logging use of the digital stamp and compensating a user for such use. Also provided are computer-readable media having computer readable instructions embodied thereon, that when read by a machine, cause the machine to perform the present methods. Further provided are computer systems that include a database having information regarding digital stamps available for a user to include in computer-implemented communications.

### CROSS REFERENCE TO RELATED APPLICATION

This application claims the benefit of U.S. Provisional Application No. 61/023,897 filed on Jan. 28, 2008, the contents of which are hereby incorporated by reference in their entirety.

### FIELD

Provided are methods, systems and computer-readable medium that facilitate individuals, such as consumers, being able to distribute or otherwise share advertisements from corporations, small businesses, non-profit organizations, and the like, to their social network of other consumers. By way of example, the present methods, systems and other embodiments facilitate a user in inserting digital stamps onto their email and/or social networking website accounts or other computer communications, such that the digital stamps ride the user's computer communications such that a second or more recipient or viewer of the computer communication also receives the digital stamp.

### BACKGROUND

Advertisements have previously been involuntarily inserted into emails by email providers. For example, an email may be sent from a Yahoo!® email account in which a Yahoo!® advertisement is automatically added to the bottom of the email by Yahoo!® such that the recipient receives the advertisement, but such advertisements are not through any voluntary action or desire of the email sender.

### SUMMARY

The present methods, systems, and other embodiments provide unique ways in which a consumer may voluntarily select and add advertisements to their emails, profiles, social networking webpages or other web communications. Non-limiting example embodiments provide methods and systems that include a user using a computer to insert a digital stamp onto the user's computer communication. The computer communication may be for example an email communication in which a user may select one or more digital stamps using a computer, where the stamps bear targeted advertisements, and inserting such stamps into e-mail sent by the user to a recipient. Further example embodiments provide methods and systems for a user to add digital stamps to the user's social networking webpage or profile or other web communications using a computer. The user may be compensated for using such digital stamps.

Also provided are computer-implemented methods in which a computer receives input from a user requesting a digital stamp; and the computer facilitates insertion of the digital stamp by the user into a computer communication for viewing by a viewer of the digital stamp. The computer communication may include for example email communication or social network web communication.

Also provided are methods in which a first computer (for example, a service provider's computer) receives a request from a user-controlled second computer, for a digital stamp, and the first computer facilitates computer insertion of the digital stamp by the user into a computer communication for viewing by a viewer of the digital stamp. Again, the computer communication may include for example email communication or social network web communication.

Further provided are computer systems that include a computer server and a database, where the database may include information regarding digital stamps available for a user to include in a computer communication.

Also provided are computer-implemented methods of transforming a computer file that includes a graphic advertiser message, into an intelligent file having computer code embedded thereon, where the computer code is capable of gathering and/or reporting data regarding use of the intelligent file, while maintaining the advertiser message on the intelligent file. The transformed intelligent file may be used in other embodiments herein as a digital stamp that may be communicated via computer by a user to a viewer.

Example embodiments also provide computer or machine readable mediums and computer readable program products relating to the disclosed methods and systems.

### BRIEF DESCRIPTION OF THE DRAWINGS

FIG. 1 is a non-limiting example of a digital stamp for commercial/for profit companies in accordance with non-limiting embodiments.

FIG. 2 is a schematic of example embodiments in accordance with non-limiting example embodiments.

FIG. 3 is a schematic of example embodiments in accordance with non-limiting example embodiments.

FIG. 4 is a schematic of example embodiments in accordance with non-limiting example embodiments.

FIG. 5 depicts a non-limiting example of how a digital stamp may be accessed from a toolbar of a mail service, such as Yahoo!®.

FIG. 6 depicts a non-limiting example of how a digital stamp may be accessed through operating system based or browser based software that is independent of any email service.

FIG. 7 depicts a non-limiting example of how a digital stamp may look once inserted into an email message.

FIG. 8 depicts non-limiting example of digital stamps for non-profit organizations in accordance with non-limiting embodiments.

FIG. 9 depicts a non-limiting example of decorative digital stamps in accordance with non-limiting embodiments.

FIG. 10 is a non-limiting example embodiment of a display a user may see, which may be used to keep track of earned credits and saved coupons, when accessing a portion of a stamp provider site.

### DETAILED DESCRIPTION

Various aspects, advantages and other features will become apparent in view of the following detailed description, which discloses non-limiting embodiments. In describing example embodiments, specific terminology is employed for the sake of clarity. However, the description is not intended to be limited to this specific terminology. It is to be understood that each specific element includes all technical equivalents that operate in a similar manner to accomplish a similar purpose.

As used herein, “a” or “an” may mean one or more. As used herein, “another” may mean at least a second or more.

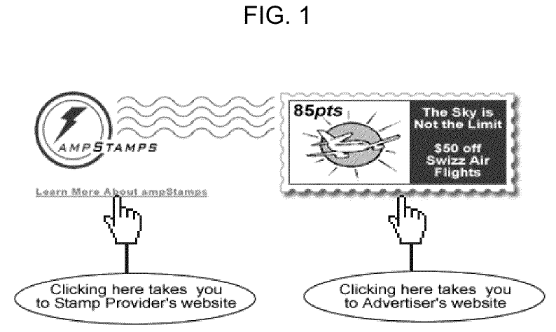

The term “digital stamps” or “stamp” as used herein may include at least one advertiser message (commercial or non-commercial, such as charitable), banners, hyperlinks and/or any other content (including music, video or other media) that may be communicated on an email (e.g., pasted into the body of an email), webpage, on a social network web communication (such as on a profile), or other web communications, such as instant messenger and the like. Digital stamps may be displayed in a format that resembles a postage stamp as shown for example, in FIG. 1, but they are not limited to such a format, and may be in other desired formats and/or designs. Example digital stamps may include at least one advertiser message thereon and/or one or more hyperlinks that may link for example, to an advertiser's website and/or to the stamp provider's website. Example digital stamps may include one or more other hyperlinks, such as to a website for a digital stamp provider, where one (such as a recipient or viewer of a communication containing a stamp) can sign up to be able to send digital stamps themselves. Example digital stamps may be intelligent computer files having computer code embedded thereon, where the computer code may be capable of gathering and/or reporting data regarding the use of the digital stamp.

As indicated above, provided herein are unique ways in which a consumer may voluntarily select and add advertisements to their emails, profiles, social networking web pages or other web communications, which may be an advantageous form of targeted viral marketing. Because the user selects the digital stamp/advertisement to be inserted onto their email, it is likely that advertisements may be more accurately targeted to recipients or other viewers of the advertisement who may be interested in such advertisements. Additionally, the present methods, systems and other embodiments provide incentives for a user to communicate such targeted advertising. Such advertising may be facilitated e.g., by allowing the digital stamps/advertisements to be inserted into any of a computer user's computer communications (such as email from any email provider or any social networking website), and/or by suggesting digital stamps or stamp ads to a user e.g., based on the user's profile.

Non-limiting example embodiments provide methods and systems that include a user inserting a digital stamp using a computer, onto the user's computer communication. The “digital stamp” in this and other embodiments herein may be an intelligent file having computer code embedded thereon, where the computer code is capable of gathering and/or reporting data regarding use of the digital stamp. The digital stamp may have at least one advertiser message thereon. The computer communication may include at least one of email communication and social network web communication. According to non-limiting example embodiments, the user may be compensated for using such digital stamps.

The computer communication may be for example an email communication in which a user may select one or more digital stamps using a computer and inserting such stamps into e-mail sent by the user to a recipient. Further example embodiments provide methods and systems for a user to add one or more digital stamps to the user's social networking webpage or profile or other web communications using a computer. A social network web communication is a form of individual-to-individual communication, so as with email communication, when a digital stamp is displayed on a social network webpage, it acts as a form of individual-to-individual communication, so any advertising on the social network page is somewhat targeted with respect to who the advertising is from and/or to.

In embodiments in which the computer communication is an email communication the inserting step may include using a computer to insert a digital stamp into a user's email message for display in the email message such that a recipient of the email may view the digital stamp on a display after receiving the email. Such methods may include using a computer to send the email message to at least one recipient.

Example embodiments also provide methods and systems for a user of a social network to add digital stamps to the user's social network webpage or communications. Thus, the inserting step may include using a computer to insert a digital stamp into a social network web communication, such as on a profile or home page of the user, such that viewers of the user's social network webpage may view the digital stamp on a display. Social networks may include for example Facebook, Google's™ Open Social and the like. As part of a social network, users may add a digital stamp to their page or profile. Additionally, digital stamps may be present as part of a user profile in any forum that includes multiple users, such as iVillage®, Yahoo!® groups and the like. Digital stamps may also be added to other websites, such as personal or family websites that are not necessarily part of a social network.

According to non-limiting example embodiments “recipients” or “viewers” may include not only the person or persons to whom the communication is directed or intended by the user, but also any other downstream viewers or recipients. For example, persons who are cc'd or bcc'd on email communications would be included within the meaning of “recipients” or “viewers”. Also included would be persons to whom emails are forwarded from an earlier recipient, regardless of how far downstream from the initial recipient. With respect to social network web communications viewers may include for example, persons designated as “friends” of the user (e.g., on Facebook), but also friends of friends and anyone else who may be able to view any portion of the user's communication that may include a digital stamp.

Insertion of a digital stamp may be performed by a user using a computer to actively insert the digital stamp on the computer communication or by a user pre-designating, e.g., using rules to insert the digital stamp on a computer communication. In an example of the computer communication being email, the digital stamp may be inserted on the computer communication by a user on each individual email or it may include a user setting up rules or pre-designating which digital stamps to use on emails to be sent to recipients in the future. For example, a user may set up a rule whereby the first 10 emails they send out a day may have a certain stamp on them, or a rule where certain recipients receive a certain kind of stamp (e.g., particular recipients receive a selection of non-profit stamps, or clothing advertisers, or cosmetic advertisers or the like). The insertion need not require selection of an exact stamp for an exact recipient, but may include a subset or type of stamps and/or may be directed to certain types of recipients (e.g., the next 5 recipients, business recipients, family recipients, friends, or other groups may be designated). Additionally, insertion may allow the user to place the stamp at a desired location within the email body, or the user may set a preference for the top or bottom of the email, or the location may be preset by the email service provider.

In an example of the computer communication being social network web communications, insertion of a digital stamp may be active insertion by a user on each individual webpage or communication or it may include a user setting up rules or pre-designating which digital stamps to use. For example, a user may set up a rule whereby certain pre-selected digital stamps (such as stamps for five favorite organizations) may rotate, scroll, or otherwise show alternatively on a webpage or profile. The insertion need not require selection of an exact stamp for the world to see, or for a viewer of the page or profile, but may include a subset or type of stamps and/or may be directed to certain types of viewers of the page or profile (e.g., the next 5 viewers, business viewers, family viewers, friends, or other groups may be designated). By way of further example, the user may set up a rule such that if certain persons or persons with something specific in their profile (e.g., they are a parent) view the page, a pre-selected digital stamp (such as for diapers) appears, and if persons with different profiles view the page (e.g., they have a dog), a different digital stamp appears on the page (such as for dog food).

Methods herein may include the user registering with a digital stamp provider or service over a data communications network using a computer. The user may register as part of a process of inserting a stamp onto a computer communication, or the user may register with the digital stamp provider prior to using a digital stamp, e.g., before inserting a digital stamp on an email communication or before inserting a digital stamp onto a social network web page.

Upon registering with the digital stamp provider, an account may be created for the user and the user becomes a Subscriber of the digital stamp service. User or Subscriber accounts may include e.g., information regarding a user's preferences regarding digital stamps, payment options for receiving cash rewards for sending the digital stamps (e.g., bank account number or PayPal™ or other online payment system information), name, address, and the like. User or Subscriber accounts may also include demographic information regarding the Subscriber or User that may be used for example in facilitating a selection of appropriate digital Stamps to recommend to the Subscriber. Thus, according to non-limiting example embodiments, registering may provide user profile information to a server, which information may be stored on the server and used to suggest digital stamps to the user on a computer display prior to the user inserting a digital stamp onto a computer communication. Example methods and systems may have built in security measures to prevent hacking.

Also provided are computer-implemented methods that include a computer receiving input from a user requesting a digital stamp; and the computer facilitating insertion of the digital stamp by the user into a computer communication for viewing by a viewer of the digital stamp. The computer communication may include for example email communication or social network web communication. The digital stamp may have at least one advertiser message thereon and it may be an intelligent file having computer code embedded thereon, where the computer code is capable of gathering and/or reporting data regarding use of the digital stamp.

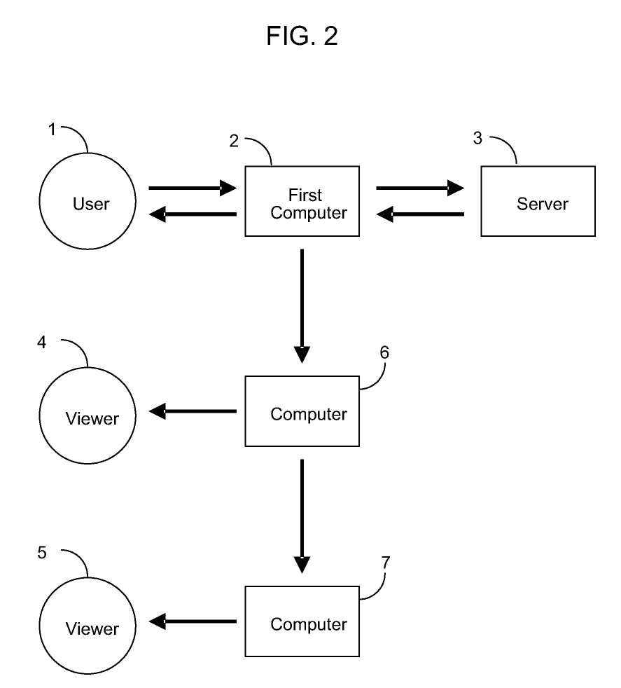

Referring to FIG. 2, for example, the methods may include for example, a first computer 2 receiving input from a user 1 requesting a digital stamp, and facilitating insertion of the digital stamp into a computer communication. The first computer 1 may then communicate with a server or other computer system 3 that can provide digital stamps that a user may include on a computer communication. A viewer of the digital stamp may be for example an initial email recipient (e.g., a first viewer 4 in FIG. 2) or a second viewer 5 to whom the first viewer 4 forwarded the email communication. It should be noted that FIG. 2 is highly simplified in that it does not depict for example networks that may allow an email message to be transmitted by computer 1 for viewing e.g., on a second computer 6 and/or a third computer 7 or more. Example methods may include the computer 2 communicating the digital stamp to at least a second computer 6 having a display on which at least one viewer can view the digital stamp.

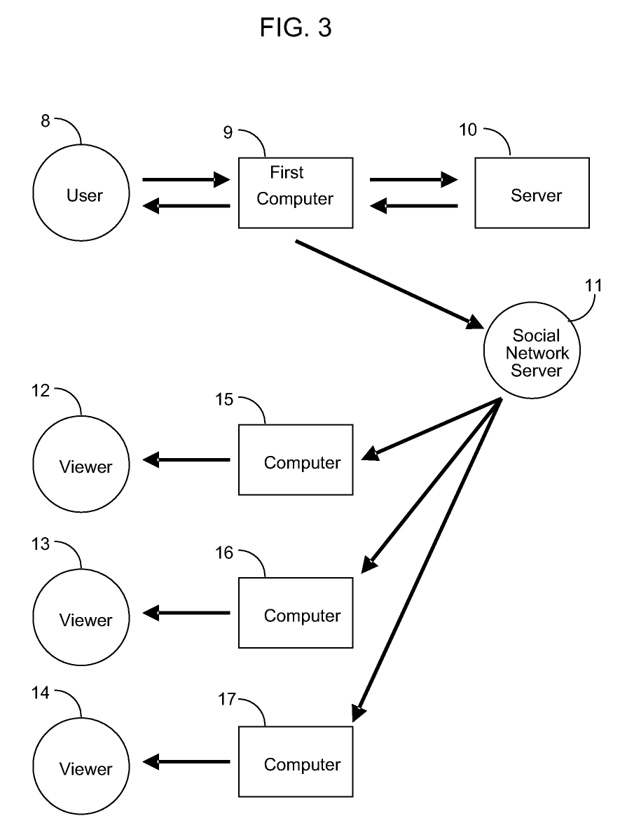

FIG. 3 is a depiction of example embodiments in which a computer 9 facilitates insertion of at least one digital stamp where the computer communication may be a social network web communication. Referring to FIG. 3, the methods may include for example, a first computer 9 receiving input from a user 8 requesting a digital stamp, and facilitating insertion of the digital stamp into a computer communication. The computer 9 may then communicate with a server or other computer system 10 that can provide digital stamps that a user may insert e.g., onto their social network webpage, using the computer 9 in communication with a social network server 11 via the internet. One or more viewers (e.g., viewers 12, 13, and 14) may then view the social network webpage e.g., via display on one or more second, third, fourth or more computers (computer 15, computer 16 and computer 17).

Also provided are methods in which a first computer (for example, a service provider's computer) receives a request from a user-controlled second computer, for a digital stamp, and the first computer facilitates computer insertion of the digital stamp by the user into a computer communication for viewing by a viewer of the digital stamp on a computer display. Again, the computer communication may include for example email communication or social network web communication.

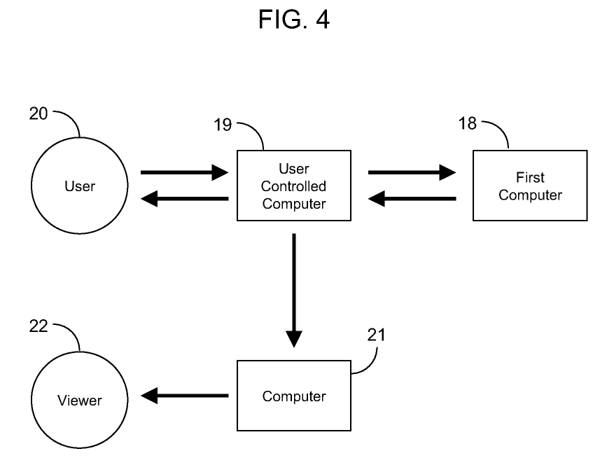

By way of example, referring to FIG. 4, example methods are computer-implemented methods that include a first computer 18 receiving a request from a user-controlled second computer 19, for a digital stamp, and the first computer 18 facilitating computer insertion of the digital stamp by the user into a computer communication for viewing by a viewer 22 of the digital stamp on a computer display 21. As with FIGS. 2 and 3, FIG. 4 is also a simplistic schematic and is meant to encompass communications that occur via internet communications. Such computer communication may include for example email communication or social network web communication.

As with other embodiments discussed herein, the digital stamp may have at least one advertiser message thereon and it may be an intelligent file having computer code embedded thereon, where the computer code is capable of gathering and/or reporting data regarding use of the digital stamp.

Example methods may further include a computer logging a user's use of a digital stamp in computer communications, wherein the use includes a user inserting a digital stamp onto a computer communication, using a computer.

According to example embodiments methods may further include providing recommended digital stamps to the user-controlled computer, e.g., based on the profile of the user, for display to the user prior to facilitating computer insertion of the digital stamp onto the computer communication.

Example methods may also include charging an advertiser for a user's use of a digital stamp having the advertiser's message thereon. Advertisers may also pay a fee for example to appear on a list of recommended digital stamps that may be provided to a user—or to appear more prominently (e.g. at the top or in bold) on a recommended list.

Example methods herein may further include compensating the user for inserting a digital stamp into a computer communication. Digital stamps may further include at least one hyperlink to an advertiser's website and user compensation may be determined at least in part based on whether the viewer clicks on a hyperlink on the digital stamp. User compensation may be further determined based on whether the viewer makes at least one purchase from the advertiser's website.

Digital stamps may be inserted into any email software including webmail (e.g., Hotmail, Yahoo!®, Gmail™), etc. and email client software (e.g., Microsoft Outlook or Lotus Notes). According to non-limiting embodiments, the stamp provider may automatically log the use of the stamp-ad to compensate (e.g., allot points to) the Subscriber and charge the advertiser accordingly. Alternatively, there may be a time delay before allotting points, such that the email recipient has time to click on the stamp where the stamp is hyperlinked to the advertiser's website (for example as shown in FIG. 1), and view the advertiser's web page, and/or make a purchase therefrom (which may affect the compensation).

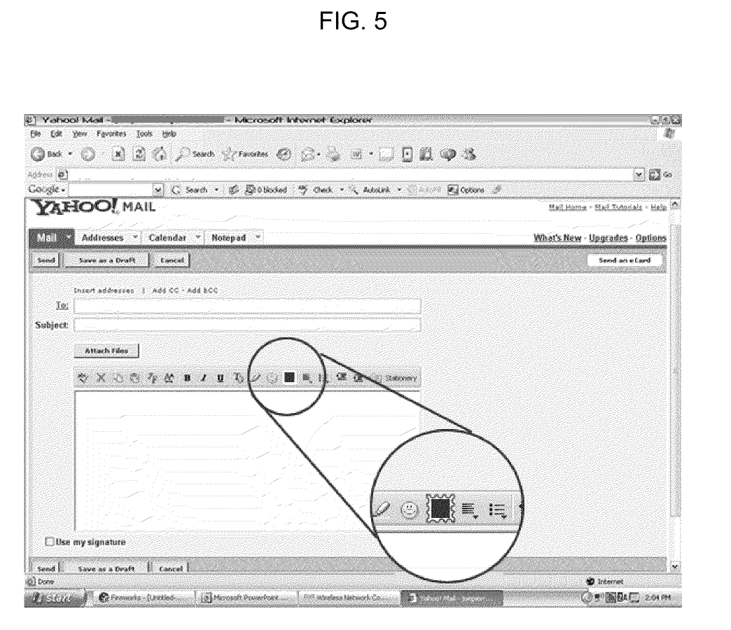

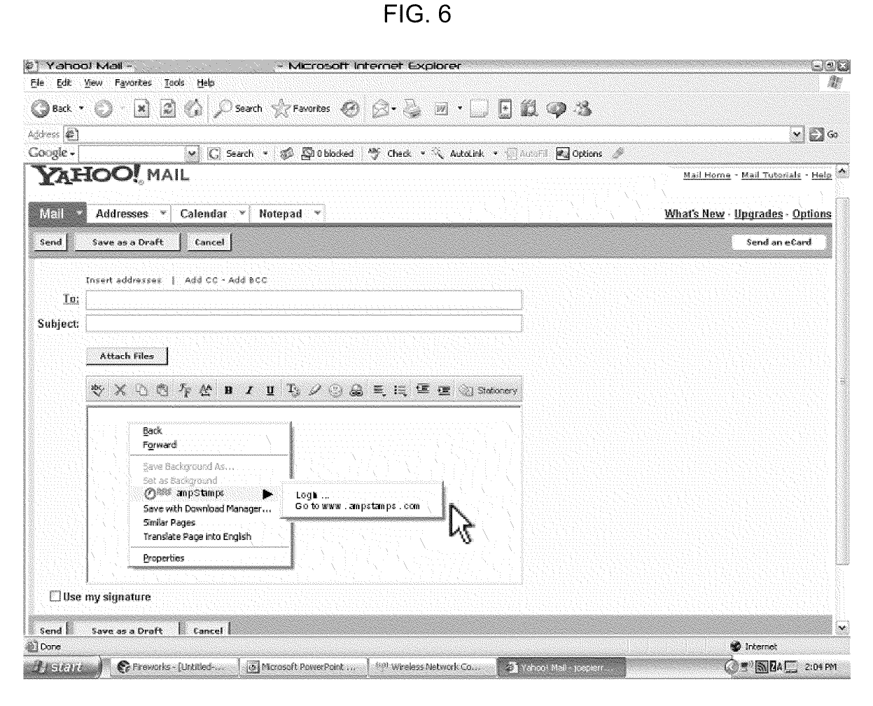

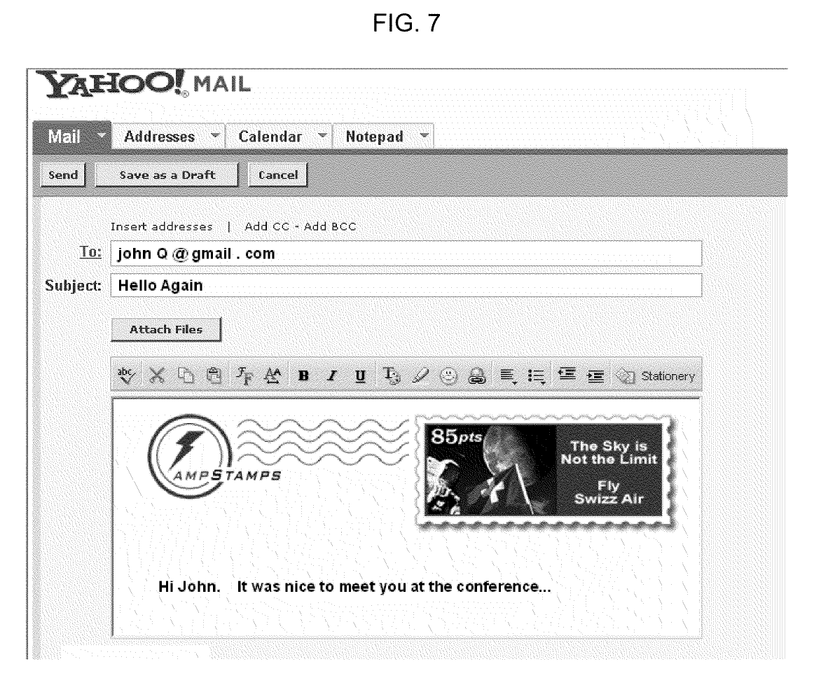

According to example embodiments, the user may be required to download software to browse and select digital stamps. According to other example embodiments, transactions relating to any of the present methods may be conducted within a website, which does not require a user to download additional software to participate. By way of example, software may already be part of a social networking website, such that no software download is required by the user. According to further example embodiments, a user may select a stamp from a web or email toolbar (such as a Yahoo!® toolbar or Google™ toolbar that is already present when the user is creating an email in such systems), for example, where the stamp service is tied to the email software allowing stamps to be inserted (see e.g., FIG. 5). Alternatively, the stamps may be independent of any email service as depicted for example in FIG. 6 and explained in Example 3 below. According to other example embodiments, stamps may be copied and pasted from the stamp provider website into an email (or onto a webpage or profile). A non-limiting example of how a digital stamp may look after being inserted into an email is depicted in FIG. 7.

Methods provided herein may include various incentive programs, in which users may be compensated for using the digital stamps (e.g., as part of an email communication or as part of their participation in a social networking website), in exchange for credits that may be redeemed e.g., for monetary compensation, discounts on merchandise purchases, free merchandise, lottery entry, coupons or credit from the advertiser, or an opportunity to donate to charity. In the case of email for example, a user may be compensated for inserting stamps into email sent by the user that include such stamps. The discounts, coupons, credits and the like may be stored and/or viewed in a digital coupon box, where credits may be held and offers saved so a user can manage coupons.

The advertiser and/or digital stamp provider or service may control the type and amount of compensation that may be provided to users for various stamps and types of stamps. By way of non-limiting example, for commercial advertising, the user may be compensated monetarily and/or with credits or points that may be redeemable for merchandise, lottery entries, or donated to charity. The method of compensation may either be decided by the user after the fact, or for certain stamps, the user may be told that any compensation from use of that stamp may only be redeemed in certain ways. Monetary compensation may be set up such that the user is paid at regular time intervals (e.g., every 6 months) or after a certain amount of money is reached (e.g., $20). Such payment may be by transferring money directly to the user's bank or PayPal™ account or by checks in the mail.

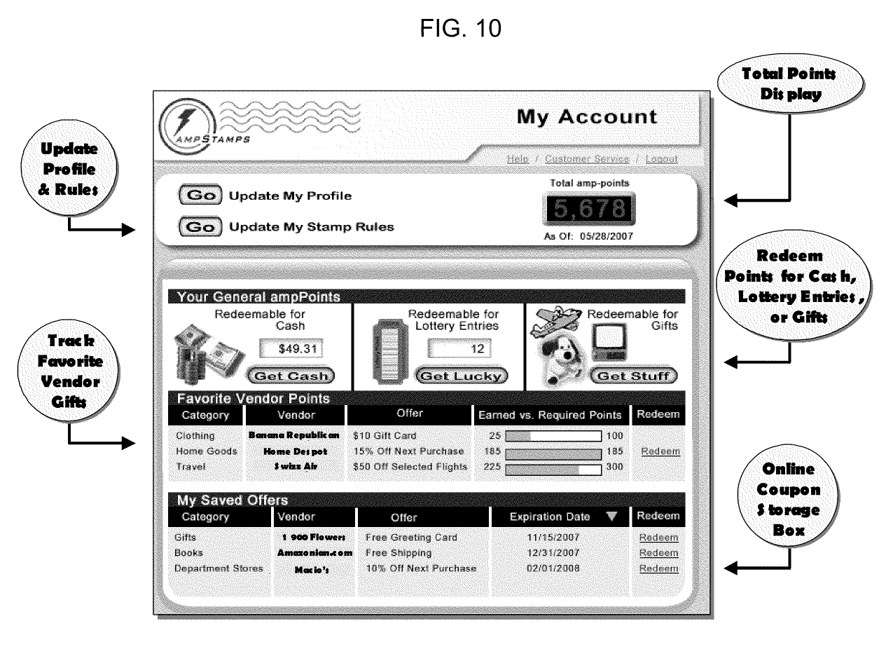

Earned credits or points may be for example “general” points that may be redeemed for cash or for merchandise in an on-line store, or “vendor specific” points that may be redeemed for merchandise or for offers (such as “$10 off”) from a specific merchant. The stamp provider may provide a system to keep track of how many additional points are needed before a desired item or offer may be obtained by redeeming the points. By way of non-limiting example, see FIG. 10. Compensation may also include receiving coupons or credit directly from the advertiser.

As indicated above, according to non-limiting embodiments, vendor specific points may be earned. These points may be earned for example, by selecting a stamp-ad from a specified vendor. The Subscriber will be informed that the use of such a stamp can only be applied toward a gift certificate or points for purchases from the specified vendor. The more the Subscriber chooses and sends the vendor's stamp, the closer they get to redeeming the gift certificate or points. This allows brand loyal Subscribers to earn rewards with their favorite vendors and track these rewards on a single computer user interface. It also recruits the Subscriber to do marketing for the vendor, effectively allowing the advertiser to outsource their marketing efforts. The advertiser further benefits when the Subscriber spends the gift certificate at their store, generating even more revenue.

Levels of compensation may be provided depending on various factors. For example, sending an email having a digital stamp may receive one level of compensation, if the recipient clicks on a hyperlink in the digital stamp, the sender may receive greater compensation, and if the recipient actually makes a purchase from an advertiser after clicking on the digital stamp, the sender may receive even greater compensation. This type of compensation structure may encourage users to use digital stamps they believe a recipient might be most interested in or most likely to make a purchase from. This is a targeted form of viral marketing. The advertiser may also be charged advertising fees by the stamp provider in such an incremental, action based method/scale. The amount and type of compensation may depend on other factors, such as the type of use of the stamp (e.g.,on a web page, on an IM communication), the length of use, the number of profile or page views, etc. It is contemplated that compensation may be set for maintaining the stamp on a page or profile on a weekly, monthly or yearly basis, or alternatively for the number of page or profile views (potentially having a maximum number of views for which a user will be compensated). Also, various levels of compensation may be provided depending on other various factors. For example, having a digital stamp on a user profile may receive one level of compensation, if a viewer of the page or profile clicks on a hyperlink in the digital stamp, the user may receive greater compensation, and if the viewer of the page or profile actually makes a purchase from an advertiser after clicking on the digital stamp, the user may receive even greater compensation. This type of compensation structure may encourage users to use digital stamps they believe their web viewers might be most interested in or most likely to make a purchase from. The advertiser may also be charged advertising fees by the stamp provider in such an incremental, action based method/scale.

It is contemplated that an email being sent by the user may include multiple digital stamps. Compensation to the user for each stamp may depend on the number of stamps included in the email being sent.

Merchandise that can be redeemed as user rewards may include for example, merchandise in an online store. The online store may be an independent entity, tied to the digital stamp service, or alternatively a storefront where partnerships are formed with companies, such as one or more advertisers that issue digital stamps. By way of non-limiting example, as a user/Subscriber accumulates points, they will be able to visit the stamp provider website to check point balances, redeem cash for points, or browse a catalogue of goods and services from participating vendors for which they can redeem their points.

It should be understood that the names of the credits and the ways in which they may be earned and/or redeemed may vary greatly in accordance with example embodiments.

Digital stamps themselves may include coupons or offers. For example, if a recipient of the stamp clicks on the stamp (e.g., a hyperlink on the stamp), the recipient may receive a discount on the advertised item or from the advertised company.

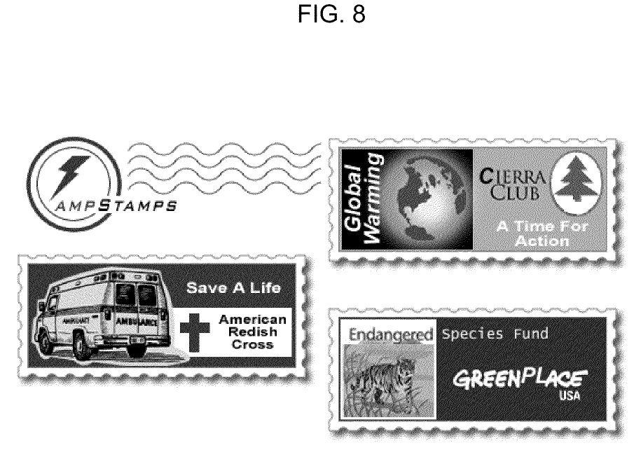

According to non-limiting embodiments, stamps may include ads from non-profit organizations. An example of such non-profit stamps is depicted in FIG. 8. The stamp service may charge little or no advertising fees to non-profits, depending for example on the size of the organization's budget. Because of the lower (or non-existent) revenue from non-profit stamps, Subscribers may not be able to earn points toward cash or prizes when they use the non-profit stamps. However, Subscribers using such stamps may be rewarded with “Karma Points” (which may be just symbolic) for spreading the word of their favorite non-profits as they send these stamps. The tally of Karma Points may be illustrated when the Subscriber logs on to the Stamp service.

As indicated above, Subscribers may donate cash that they would have redeemed from their General points to any participating non-profit of their choosing, thus creating a new source of funding for participating non-profits. Subscribers who do this may be able to print a receipt from such transactions for tax deduction purposes.

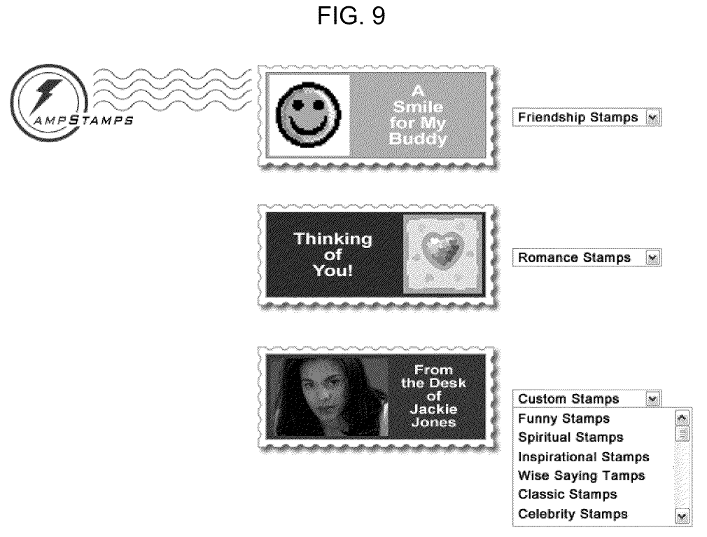

Further embodiments may include decorative stamps for users/Subscribers, which may be used e.g., for decorating email or social web communications. By way of non-limiting example, such stamps may include Friendship Stamps, Romance Stamps, Funny Stamps, Smart Stamps, Holy Stamps, Wise Stamps and the like. FIG. 9 depicts non-limiting example embodiments of possible decorative stamps. Other examples may include Customized Stamps/Make your own, which may be used for example, as a kind of a personal seal or stationary in a user's emails. The service can generate many different styles for the user or let them create their own with a wizard (pick shape, background, border, text style, type in your text, images). According to certain embodiments, such decorative stamps may be offered to users for free, or users may redeem previously earned points to use such decorative stamps. Alternatively users may pay a fee to use such decorative stamps.

Further included are methods that include receiving a request from a user for a digital stamp; facilitating the user inserting the stamp on an email being sent by the user to an email recipient. Methods may further include processing a credit of an account corresponding to the user based on which stamp is used and on various other factors that may include whether the stamp led to a website view and/or purchase by the email recipient.

Methods and systems are also provided for organizing or displaying stamps for users to easily find relevant or desired stamps, e.g., based on preferences set up by the users or based on other targeted marketing techniques. The user can also browse stamps by category or use the system/service to search for stamps by keyword, type, company, and other search criteria.

Before a user selects any stamps, advertisers may first take out an ad by opening an account with the stamp provider. At least one stamp design is then created for the advertiser (either by the advertiser or by the stamp provider), and fees are agreed to between the advertiser and stamp provider, and with respect to what fees will flow to a user that includes a stamp on their email (or web page or profile as discussed further below).

As with other embodiments described herein, according to example embodiments, the user may be required to download software to browse and select digital stamps. According to other example embodiments, transactions relating to any of the present methods may be conducted within a secure website, which does not require a user to download software to participate. Or the stamps may be selected from a tool bar or menu e.g., on a social network page.

It is contemplated that a user profile or page may include multiple digital stamps. Compensation to the user for each stamp may depend at least in part, on how predominately the particular stamp is displayed on the page or profile. For example if only one stamp is used and it is at the top and center of the page, the user may receive greater compensation than if the stamp is buried as one of 20 stamps at the bottom of a page that a user has to scroll down to see.

It is further contemplated that digital stamps may be inserted into other electronic communications including for example, IM communications or webcam video communications for example via Windows Live Messenger or Skype™. For example, if a user invites another person to a video communication, a window that appears on the other person's computer may appear with a digital stamp selected by the user.

Further included are methods that include receiving a request from a user for a digital stamp; and facilitating the user to insert the stamp on a webpage, profile or other internet communication. These example methods may also include compensating the user. Such compensation may include for example, processing a credit of an account corresponding to the user based on which stamp is used and on various other factors that may include whether the stamp led to a website view for the advertiser and/or purchase by the page or profile viewer.

Example embodiments also provide computer systems that include a computer server coupled to a database. The database may include for example, information regarding digital stamps that may be available for a user to include in a computer communication, such as an email communication, social network web communication and the like. Such information may include for example, artwork associated with at least one digital stamp, hyperlink information, and information regarding how much a user may be compensated for using such a digital stamp in various media, and the like. In example embodiments a digital stamp has at least one advertiser message thereon and is an intelligent file having computer code embedded thereon. The computer code may be capable of gathering and/or reporting data regarding use of the digital stamp, which may be useful for example in tracking use of the digital stamp by users. Such tracking may be used e.g., to determine compensation to be awarded to users.

In example systems, the server may be adapted to monitor and/or control usage of the stamps. Monitoring may include for example, automatically monitoring the ads selected by users/Subscribers of the service, recording the accompanying Click-through Rates of their email recipients, and/or matching this data against the Subscriber's profile data. Adding this information to the individual user's profile will help a stamp service provider create a fuller picture of each Subscriber in the database, specifically telling the provider about the user's actual product interests and proclivity to respond to certain types of promotions. This information may help tailor which stamps are recommended or predominately appear when a user goes to select their next stamp. This information may also be used to offer the advertisers a more detailed understanding of Subscribership to the service, helping them to develop and target more relevant ads that will motivate action.

Control may be useful for example to limit the number of times a particular stamp may be used by all users (for example if the advertiser only wishes to compensate e.g., for 1000 uses of its stamp), limit the number of times a user may send a particular stamp, limit the overall uses by a user of all stamps, limit daily uses of a stamp or by a user, limit the number of times stamps may be sent to a recipient, etc. Such limits or controls may be desirable for example to prevent abuse of the methods and systems, such as to prevent a user from obtaining profits by using stamps sent in bulk SPAM email.

Example systems may include search engines, drop-down menus, browsing tools or other tools that may be used by users to browse or search for a stamp or type of stamp with available stamps or types of stamps. The stamp provider may provide recommended stamp-ads based on the user's profile, or may provide stamps in a directory format, with stamps being organized. With an ever-changing database of digital stamps, such organizational tools may assist users in efficiently locating the stamp or type of stamp they wish to use.

According to non-limiting embodiments, a system may be set up as part of the user account with the stamp provider that is capable of keeping track of monetary compensation, earned credits or points, and/or coupons or offers that a user wishes to save and potentially redeem at a later time. By way of non-limiting example, a “my account” webpage may illustrate an “online coupon storage box” or other section for such saved coupons or other offers, which allows users/Subscribers to save the stamps that advertise offers that are appealing to them. FIG. 10 depicts a non-limiting example of a possible “my account” webpage. It is not only an email recipient or other viewer of a stamp who may want to click on a stamp to enjoy an offer. As users/Subscribers browse the stamps that they can send or display on their webpages, they may like the offer that they see on the stamp for them self. In this case they can save the stamp to their account and click thru on the stamp whenever they are ready to use it. The system may also allow email recipients to save stamps that they receive to their own account if they also are a Subscriber. A “Saved Offers” section of the web page for example, may be organized by product/service categories. It can also feature an expiration date on each offer to allow the Subscriber to sort the offers by this date and recognize which ones are expiring sooner. The system may also be set up to send an email or telephone alert to the Subscriber whenever one of their Saved Offers is about to expire.

Example systems may also include a display of a digital stamp collection, to allow users to save particular stamps that they have used, that they like the look of etc. Such a stamp collection may be retained for viewing by the user, even if the stamp is no longer available to add to an email or to add to a webpage or profile for others to view.

Also provided are computer-implemented methods of transforming a computer file that includes a graphic advertiser message, into an intelligent file having computer code embedded thereon, where the computer code is capable of gathering and/or reporting data regarding use of the intelligent file, while maintaining the advertiser message on the intelligent file. Thus, example methods include receiving a file to a computer in which the file has a graphic advertiser message thereon, and transforming using a computer the file into an intelligent file having computer code embedded thereon, said computer code being capable of at least one of gathering and reporting data regarding use of the intelligent file, while maintaining the advertiser message on the intelligent file. The transformed intelligent file may be used in other embodiments herein as a digital stamp that may be communicated via computer by a user to a viewer.

Example methods may further include using the data to perform on a computer at least one of determining compensation for a user of the intelligent file, charging the advertiser for a user's use of the intelligent file; and/or reporting to an advertiser demographics of users of the intelligent file.

Methodologies discussed herein or portions thereof can be embodied on computer or machine-readable mediums, which terms are known to those skilled in the art. Accordingly, example embodiments provide computer or machine readable mediums and computer readable program products relating to the disclosed methods and systems.

Example computer-readable medium can include computer readable instructions or code segments embodied thereon, that when read by a machine, cause the machine to perform methodologies described herein. By way of non-limiting example, the computer readable medium may be adapted to facilitate computer insertion of a digital stamp by a user into a computer communication. By way of further example, the computer-readable medium may be adapted to facilitate a user-controlled computer to permit user selection of a digital stamp using a web or email toolbar.

Example embodiments may also include computer readable program products, which include a computer readable medium and a program for performing various methods and functions described herein or portions thereof.

The following examples illustrate specific example embodiments. The examples set forth herein are meant to be illustrative and should not in any way serve to limit the scope of the claims. As would be apparent to skilled artisans, various changes and modifications are possible and are contemplated within the scope of the application, and may be made by persons skilled in the art without departure from the spirit of the invention.

### EXAMPLE 1

FIG. 10 shows a non-limiting example of a stamp service provider display. According to this example, various earned points and saved offers may be displayed. FIG. 10 shows a “my account” page displaying earned “general” points, “vendor specific” points, as well as an online coupon storage box entitled “saved offers”

### EXAMPLE 2

FIG. 5 depicts a non-limiting example of how stamps may be accessed by clicking an icon, on a toolbar of a mail service, such as Yahoo!®. By clicking the icon a pop-up window might appear to allow a user to easily select a stamp. The pop-up window might include controls for the user to search stamps by various search criteria or browse stamps by categories for example, pre-selected “favorite” stamps by the user, or recommended stamps by the service provider or a broader menu of selections.

### EXAMPLE 3

FIG. 6 depicts a non-limiting example of how a digital stamp may be accessed through operating system based or browser-based software that is independent of any email service. In example methods, the user would be required to download software from the Stamp Provider. The software may work for example, in conjunction with the operating system or browser on the user's computer. After the user logs into their email service, they may simply point their mouse on the area of the screen where they want the stamp to appear in the email. The user may then right-click with their mouse. The Stamp Provider's software may provide right-click menu options for the user to log into the Stamp Provider service and retrieve stamps. The stamp may then be pasted into the email, at the location where the user's mouse was pointing on the screen. Such a design would allow the Stamp Provider to make stamps available to users without integrating systems with email providers.

Although certain specific embodiments have been described, many additional modifications and variations would be apparent to those skilled in the art. It is therefore to be understood that embodiments may be practiced other than as specifically described. Thus, the present embodiments should be considered in all respects as illustrative and not restrictive.

What is claimed is:

1. A method comprising
inserting, using a computer, a digital stamp onto a user's computer communication;
wherein said digital stamp has at least one advertiser message thereon and is an intelligent file having computer code embedded thereon, said computer code being capable of at least one of gathering and reporting data regarding use of the digital stamp; and
wherein said computer communication comprises at least one of email communication and social network web communication.

2. The method of claim 1, wherein said inserting is performed by a user using a computer to actively insert the digital stamp on the computer communication or pre-designating the digital stamp to be inserted on the computer communication.

3. The method of claim 1, wherein said inserting comprises inserting a digital stamp into a user's email message for display in the email message; and wherein the method further comprises using a computer to send the email message to a recipient.

4. The method of claim 1, further comprising registering the user with a digital stamp provider over a data communications network using a computer.

5. The method of claim 4, wherein said registering provides user profile information to a server, which information is stored on the server and used to suggest digital stamps to the user on a computer display prior to the user inserting a digital stamp onto a computer communication.

6. A computer-implemented method comprising
receiving a request from a user-controlled computer for a digital stamp; and facilitating computer insertion of the digital stamp by the user into a computer communication for viewing by a viewer of the digital stamp, wherein said computer communication comprises at least one of email communication and social network web communication;
wherein said digital stamp has at least one advertiser message thereon and is an intelligent file having computer code embedded thereon, said computer code being capable of at least one of gathering and reporting data regarding use of the digital stamp.

7. The method of claim 6, further comprising logging, using a computer, a user's use of a digital stamp in computer communications, wherein said use comprises a user inserting using a computer a digital stamp onto a computer communication.

8. The method of claim 7, further comprising compensating the user for inserting a digital stamp into a computer communication.

9. The method of claim 8, wherein the digital stamp further comprises at least one hyperlink to an advertiser's website and wherein user compensation is determined at least in part based on whether the viewer clicks on a hyperlink on the digital stamp.

10. The method of claim 9, wherein user compensation is further determined based on whether the viewer makes at least one purchase from the advertiser's website.

11. The method of claim 6, further comprising charging an advertiser for a user's use of a digital stamp having the advertiser's message thereon.

12. The method of claim 8, wherein said compensating comprises compensating the user with credits that may be redeemed for at least one of monetary compensation, discounts on merchandise purchases, merchandise, lottery entry, coupons from the advertiser, credit from the advertiser, and an opportunity to donate to charity.

13. The method of claim 6, further comprising providing recommended digital stamps to the user-controlled computer for display to the user prior to facilitating computer insertion of the digital stamp onto the computer communication.

14. A computer system comprising
a computer server coupled to a database,
wherein the database comprises information regarding digital stamps available for a user to include in a computer communication; and
wherein said digital stamp has at least one advertiser message thereon and is an intelligent file having computer code embedded thereon, said computer code being capable of at least one of gathering and reporting data regarding use of the digital stamp; and
wherein said computer communication comprises at least one of email communication and social network web communication.

15. The system of claim 14, wherein said information comprises at least one form of information selected from the group consisting of artwork associated with at least one digital stamp, hyperlink information, and information regarding how much a user may be compensated for using a digital stamp.

16. The system of claim 14, wherein the computer server is adapted to be able to monitor and/or control usage of the digital stamps.

17. A computer-implemented method comprising
receiving input to a computer from a user requesting a digital stamp; and
facilitating computer insertion of the digital stamp by the user into a computer communication for viewing by a viewer of the digital stamp,
wherein said computer communication comprises at least one of email communication and social network web communication; and
wherein said digital stamp has at least one advertiser message thereon and is an intelligent file having computer code embedded thereon, said computer code being capable of at least one of gathering and reporting data regarding use of the digital stamp.

18. The method of claim 17, further comprising the computer communicating the digital stamp to at least a second computer having a display on which at least one viewer can view the digital stamp.

19. A computer-readable medium having computer readable instructions embodied thereon, that when read by a machine, cause the machine to perform the method of claim 6, wherein the computer readable medium is adapted to facilitate computer insertion of a digital stamp by a user.

20. A computer-readable medium having computer readable instructions embodied thereon, that when read by a machine, cause the machine to perform the method of claim 17, wherein the computer readable medium is adapted to facilitate computer insertion of a digital stamp by a user.

21. A method comprising
receiving a file to a computer, wherein the file has a graphic advertiser message thereon; and
transforming using a computer the file into an intelligent file having computer code embedded thereon, said computer code being capable of at least one of gathering and reporting data regarding use of the intelligent file, while maintaining the advertiser message on the intelligent file.

22. The method of claim 21, further comprising using said data to perform on a computer at least one of determining compensation for a user of the intelligent file, charging the advertiser for a user's use of the intelligent file; and reporting to an advertiser demographics of users of the intelligent file.
